(19) United States
(12) Patent Application Publication
(10) Pub. No.: US 2005/0122282 A1
(43) Pub. Date: Jun. 9, 2005

(54) Extension device for a flat panel display and flat panel display

(75) Inventor: Martin Bieri, Rumisberg (CH)

Correspondence Address: OLIFF & BERRIDGE, PLC, P.O. BOX 19928, ALEXANDRIA, VA, 22320, US

(73) Assignee: DICOM AG, Rotkreuz (CH)

(21) Appl. No.: 10/958,427

(22) Filed: Oct. 6, 2004

(30) Foreign Application Priority Data
Nov. 6, 2003 (EP) 03 405 797.6
Jun. 18, 2004 (EP) 04 405 380.9

(51) Int. Cl. G09G 3/20

(52) U.S. Cl. 345/55

(57) ABSTRACT

The expansion device (2) provided for the attachment of a flat panel display (1) has at least one module (31, . . . , 3n), including a computer module (31), which serves to store, transmit or process video/graphics information which is transmittable to the large-format display unit (12) of the flat panel display (1), said display unit being held by a supporting structure (10). According to the invention, the expansion device (2) has a support device (21) with at least one retaining element (2110, 2120) which is located on the top of the support device (21) and is able to engage a correspondingly designed receiving part (101) located on the bottom of the supporting structure (10) of the flat panel display (1), and which retaining element is able to hold the supporting structure (10) in a fixed position relative to the support device (21).

The invention relates to an expansion device for a flat panel display, and to a flat panel display provided with the expansion device based on the preamble of Claim 1 or Claim 10.

Specifically, the invention relates to an expansion device by which a module, including a computer module, used to store, transmit or process video/graphics information, can be coupled to the flat panel display.

Flat panel displays available on the market, which are based on liquid-crystal, plasma or electroluminescence technologies, essentially have a display unit provided with glass substrates and a pixel matrix, the display unit exhibiting an overall diagonal display measurement of more than 100 cm; a driver unit provided with a circuit board; and a housing.

The construction of such a flat panel display is described in [1], EP 1 265 210 A1. This reference further indicates that the data for the images to be displayed can be supplied, for example, through a data bus from an external data source.

Reference [2], WO 02/25943, further discloses a flat panel display designed as a multimedia playback device in which the modules required to process the television signals and a computer module performing the function of a personal computer are integrated. The user may then, at his option, display a demodulated television signal or a video signal provided by the personal computer modules on the display unit.

A disadvantageous aspect of these device is the fact that the flat panel display must be appropriately equipped to accommodate the computer module, with the result being both higher production costs and relatively larger dimensions.

In the case of flat panel displays not provided with computer modules and which function in exhibition settings or in large public facilities as information panels, and are for this purpose mounted by means of a mounting device, personal computers in notebook format are often attached in order to provide the computer-generated data or images. To this end, the personal computers are fastened to the flat panel display or the mounting device, for example, by means of straps.

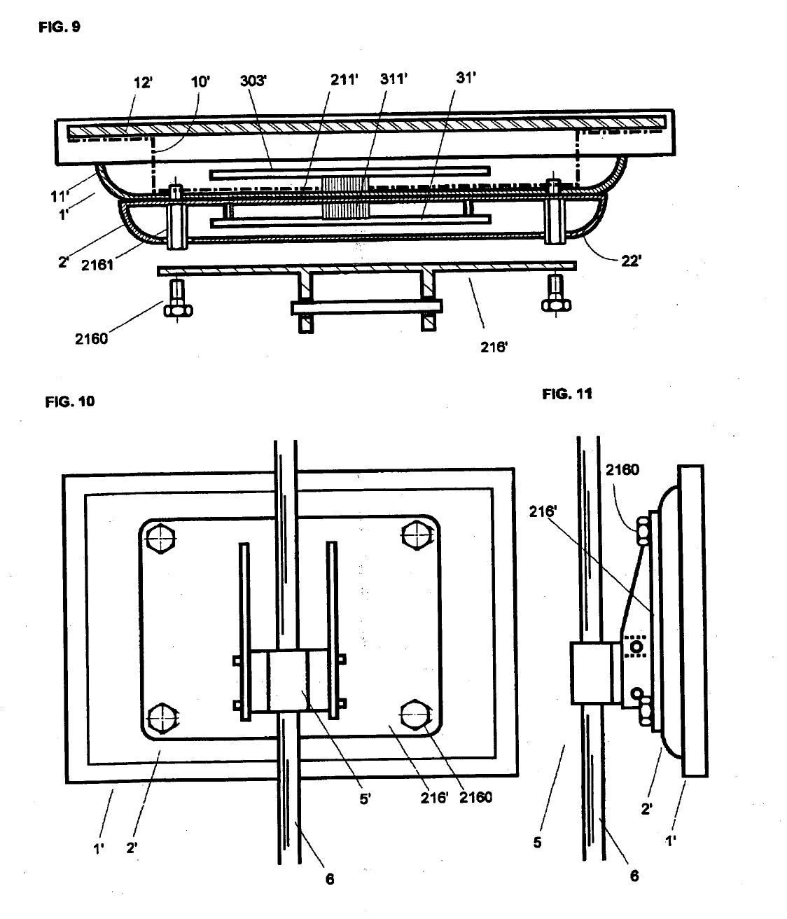

Reference [3], EP 1 244 000 A2 discloses an expansion device for a computer module, which device is designed in the form of a drawer-type compartment and is detachably connected to the back of a flat panel display. The expansion device has bulb-shaped recesses which can be inserted into nail-head-shaped fastening elements provided on the back of the flat panel display. The flat panel display can thus be coupled in a modular fashion to the expansion device. When connecting the flat panel display to a mounting device, however, the expansion device exhibits an interfering aspect. Mounting the normally quite heavy flat panel display by attaching the expansion device to the mounting device is not possible since the mounting device could detach from the flat panel display. This problem is solved by the device shown in FIG. 9 which is the subject of European Patent Application no. 03 405 797.6.

The flat panel display 1′ shown in FIG. 9, which has a display housing 11′ with a display unit 12′ and a video/graphics processing unit 303, is connected to a box-shaped expansion device 2′ which in turn has device housing 22′ which serves to accommodate at least one computer module 31 which is connectable to video/graphics processing unit 303 through a cable 311.

Computer module 31 is detachably connected to the base plate of device housing 22′, this base plate being provided with openings through which mounting screws can be passed, by means of which screws device housing 22 is connectable to the supporting structure 10′ of flat panel display 1. This results in a stable mounting of computer module 31 within device hosing 22′, and a secure attachment of device housing 22 and display housing 11 to supporting structure 10′ of flat panel display 1′.

The first mounting screws 2161 serving to mount device housing 22′ preferably have a first thread connectable to supporting structure 10′, and a spacer element which projects into or completely passes through the interior space of device housing 22′ and which is provided at the other end with a second thread which serves to accommodate a second mounting screw 2160. Flat panel display 1′ provided with expansion device 2′ is connectable to the mounting device 5′ and mountable in a stable manner on a rod 6.

The expansion device 2′ of FIG. 9 provided with computer module 31 thus allows for the stable mounting of flat panel display 1′. However, flat panel display 1′ is provided with an appropriately fitting supporting structure 10′ to which both expansion device 2′ and mounting device 5 can be attached. This furthermore results in an increased diameter for flat panel display 1′. In the event the intention is to mount flat panel display 1′ provided with expansion device 2′ in another manner, the display's supporting structure 10′ must be adapted accordingly.

The goal of the invention is therefore to create an improved expansion device, by means of which the at least one module, including a computer module, can be connected to a flat panel display. A further goal is to create a corresponding flat panel display.

Specifically, the goal is to create an expansion device which enables a flat panel display that is of simple design and economical to fabricate to be installed in various ways and at low expense.

Furthermore, the modules in the expansion device should be able to be easily augmented and replaced.

This goal is achieved by an expansion device and a flat panel display which have the features indicated in Claim 1 or Claim 10. Advantageous embodiments of the invention are provided in further claims.

The expansion device provided to connect a flat panel display serves to accommodate at least one module, including a computer module, which is capable of storing, transmitting or processing video/graphics information which is transmittable to the large-format display unit of the flat panel display, the display unit being held by a supporting structure.

According to the invention, the expansion device has a support device which is provided with at least one retaining element which engages a correspondingly designed receiving part of the supporting structure of the flat panel display and which is able to hold the supporting structure in a fixed position relative to the support device.

In a first preferred embodiment, the support device is located in a housing of the expansion device, which housing serves to accommodate the modules, and from which device the at least one retaining element projects.

In a second preferred embodiment, the support device is composed of a preferably one-piece shaped part provided with at least one retaining element, which shaped part encompasses a interior space capable of accommodating the modules. In this embodiment of the expansion device, no device housing is required. The shaped part forming the support device can be formed by bending a sheet-metal piece such that the at least one end piece projects upward, thereby forming the at least one retaining element. Preferably, both end pieces of the shaped part are bent upward. Openings for loading the support device are preferably provided on the back of the device. On the front, only such openings are preferably provided which serve to connect cables or enable insertion of data media.

The flat panel display can thus be provided with a supporting structure of simple design which can be implemented in an economical and space-saving manner, easily connected to the expansion device, or mounted on this device, and thus attached in a universally compatible manner. The expansion device thus serves not only to enable the functional expansion of the flat panel display, but also simultaneously to allow installation of the display according to the needs of the user.

The support device provided within the expansion device, which support device is attached in a stable manner to the supporting structure of the flat panel display, and thus forms an extension thereof, allows the flat panel display connected to the expansion device to be set up on the floor. To this end the support device has at least one possibly pivotable foot element, or is connectable to foot elements. Alternatively, the support device can be connected to a mounting device which is held, for example, by a rod or a wall, such that the expansion device is installed in a suspended manner and can then be connected to the flat panel display.

Installation of the flat panel display is thus not impeded but noticeably facilitated by the expansion device according to the invention. In addition, different installation variants may be implemented using the expansion device.

As a result, the flat panel display can be fabricated in a both mechanically and electronically thin form or minimal configuration, then connected at the installation site to the electronic expansion modules which are located within the expansion device while simultaneously functioning as an installation device. Flat panel displays which thus have minimal dimensions despite the large-format display unit can therefore be fabricated economically and shipped at a reduced transportation cost.

Expansion devices according to the invention can be produced at another location and configured according to the requirements of the user.

Despite the fact that multiple modules are accommodated, the expansion device can be implemented with dimensions which are essentially determined by the dimensions of the mechanical elements provided for the installation. To this end, the support device is preferably provided on both sides with pillars which have bearing surfaces for the flat panel display and which are interconnected by a center piece. The pillars and center piece form a kind of U-shape section into which one or more modules, for example, computer modules, as well as driver units for magnetic and optical storage media can be inserted. The dimensions of the expansion device are thus essentially determined by the dimensions of the support device which is in turn determined as a function of the load of the flat panel display.

Preferably, only a single interface is provided between the expansion device and flat panel display, through which interface video/graphics information is transmitted wirelessly or by wire, for example, by means of LVDS signals. Preferably, all modules which are provided in the expansion device and transmit video/graphics information to the display unit are compatible with this interface, such that in principle all of these modules can be connected to this interface. In order to provide selective connection of one or more modules to this interface, a switching unit is provided according to the invention which is controllable through a control unit.

The following discussion explains the invention in more detail based on the drawings.

FIG. 1 shows a flat panel display 1 according to the invention on which is mounted an expansion device 2 according to the invention in which multiple modules—a computer module 31, a driver unit 32 for a storage medium, and an interface module 33—are provided;

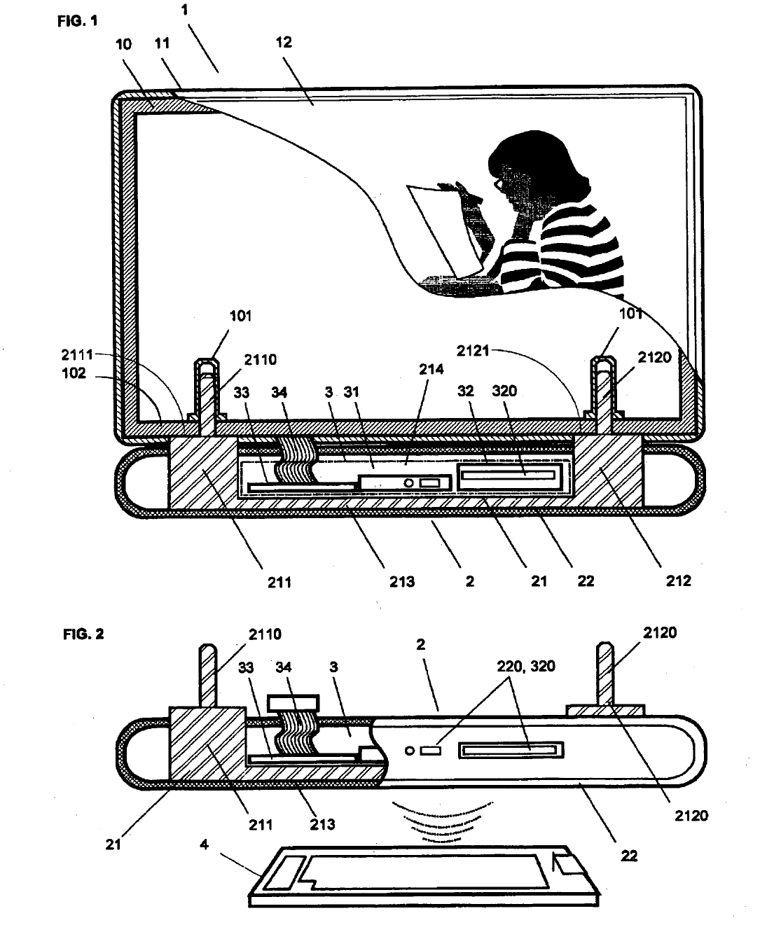

FIG. 2 shows the expansion device 2 of FIG. 1 without flat panel display 1;

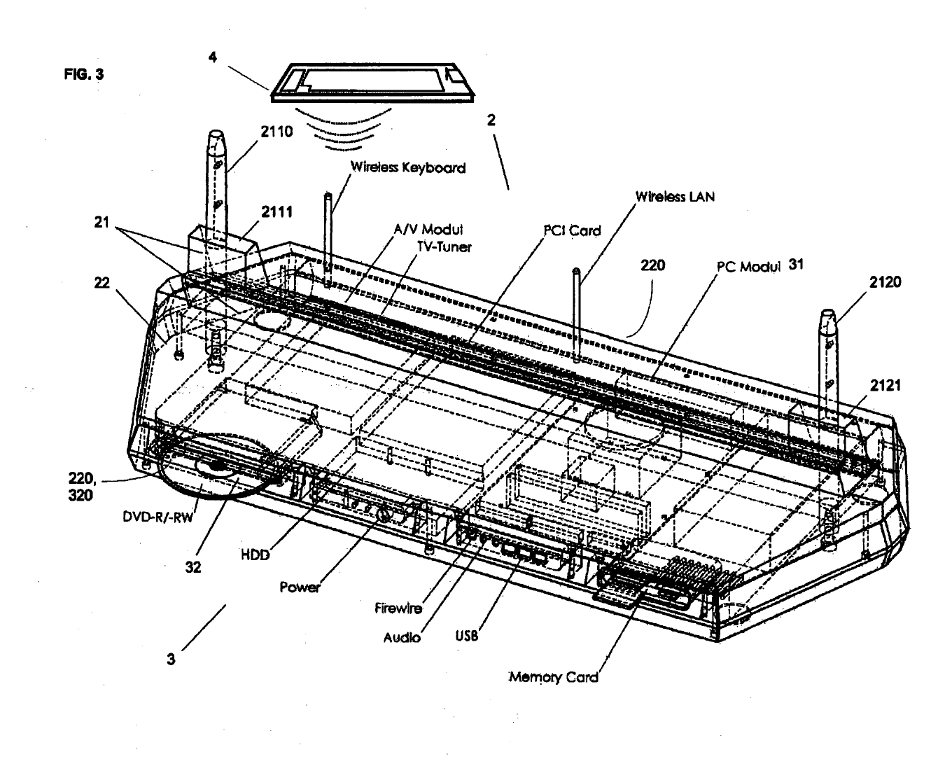

FIG. 3 shows expansion device 2 according to the invention in another preferred embodiment including modules 31, . . . , 3n which are commonly used today;

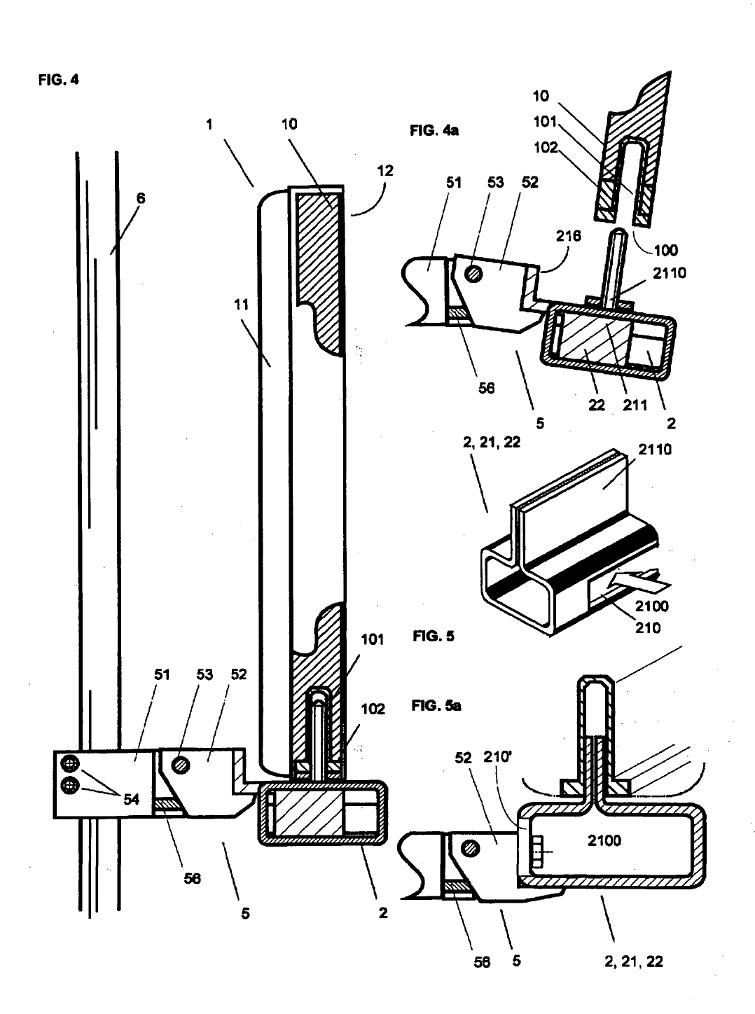

FIG. 4 shows, in yet another preferred embodiment, an expansion device 2 supporting a flat panel display 1, which device is mounted in suspended manner by means of a mounting device 5 held by a rod 6;

FIG. 4a shows expansion device 2 of FIG. 4 pivoted downward after flat panel display 1 has been lifted out;

FIG. 5 shows expansion device 2 with a support device 21 which functions both to support flat panel display 1 and accommodate modules 31, . . . , 3n;

FIG. 5a shows the expansion device of FIG. 5 connected to mounting device 5;

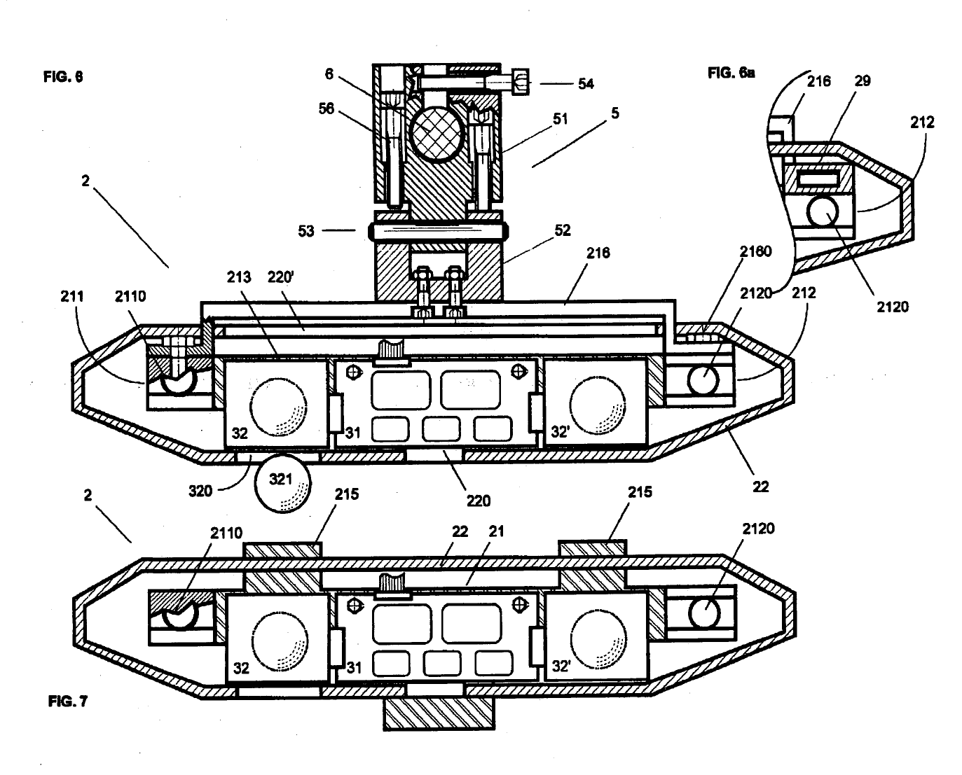

FIG. 6 shows expansion device 2 and mounting device 5 of FIG. 4 which are connected to each other by screws 2160 and seen in a sectional view from above;

FIG. 6a is a detail of expansion device 2 and mounting device 5 of FIG. 6 in a preferred embodiment with elements 29, 212 which are connectable to each other without screws;

FIG. 7 shows expansion device 2 of FIG. 6 having foot elements 215 to provide support on a base;

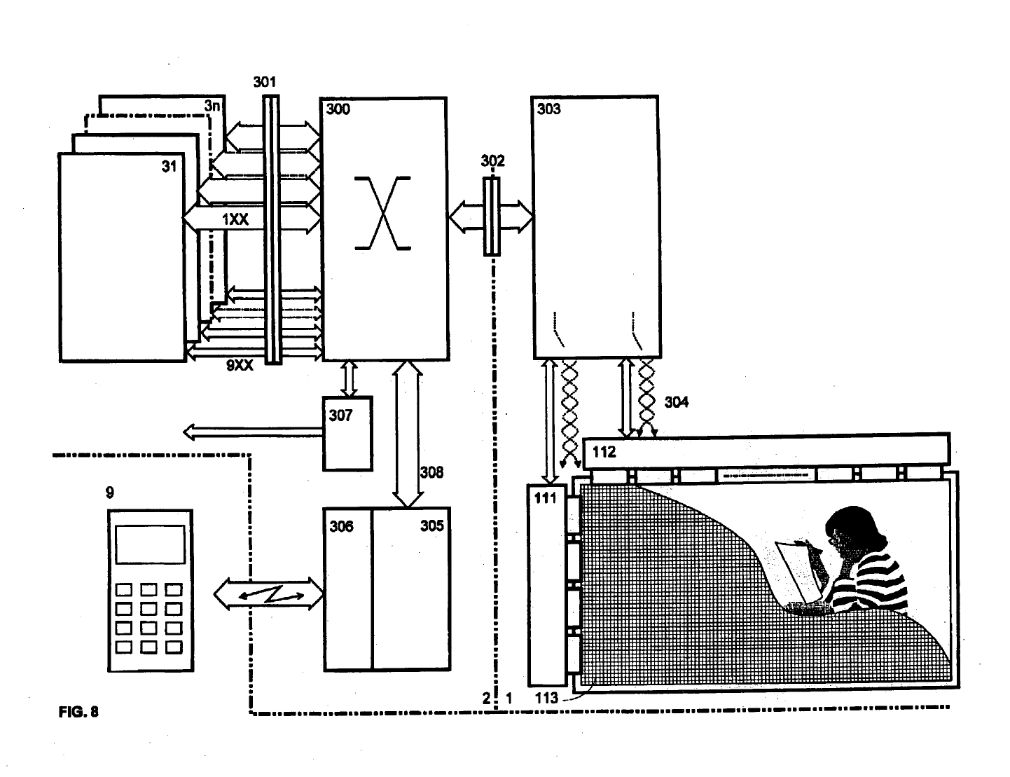

FIG. 8 is a schematic view of a circuit configuration provided in expansion device 2 having modules 31, . . . , 3n which are individually connectable to a video/graphics processing unit 303 provided in flat panel display 1 through a connection device 301, a switching unit 300, and a main interface 302;

FIG. 9 shows flat panel display 1′ and expansion device 2′ from European Patent Application 03 405 979.6.

FIG. 10 shows flat panel display 1′ and expansion device 2′ of FIG. 9 as seen from the rear; and

FIG. 11 shows flat panel display 1′ and expansion device 2′ of FIG. 9 as seen from the side.

FIG. 1 shows a flat panel display 1 according to the invention which is mounted on an expansion device 2 according to the invention which in turn has a housing 22 with a support device 21 provided therein. Flat panel display 1, which has a large-format display unit 12 located in a housing 11 and held by a supporting structure 10, is supported at its bottom side or by a structural element 102 of supporting structure 10 on support device 21 provided in expansion device 2. Supporting device 21 has two pillars 211, 212 connected to each other by a center piece 213, the pillars supporting flat panel display 1. Located on pillars 211, 212 is one each of mandrel-shaped retaining elements 2110, 2120 which engage with practically no play sleeve-shaped receiving parts 101 located on structural element 102, thereby retaining flat panel display 1 stable in a position perpendicular to expansion device 2, or to support device 21 provided therein. Retaining elements 2110, 2120, which may also be of plate-like or cuboidal form, are connected as a single-piece to support device 21, attached by screws therein (see FIG. 3), or welded thereon.

Modules 31, . . . , 3n are located between the two pillars 211, 212, which modules serve to store, transmit or process video/graphics information which is transmittable either wirelessly or by wire through cable 331 to display unit 12 of flat panel display 1. Support device 21 thus forms a U-shape section having a free space 214 in which modules 31, . . . , 3n, or possibly a set 3 including modules 31, . . . , 3n and provided with a bracket, are located. FIG. 1 shows a computer module 31, a driver unit 32 for optical or magnetic storage media, and an interface module 33 with a connecting cable 331. FIG. 3 illustrates that any desired additional modules 31, . . . , 3n, such as adapters, tuners, storage modules, power supply modules, interface modules, specifically for video, audio and control data, as well as network cards for wireless and wired networks can be located in expansion device 2. All modules which are not required to control display unit 12 and must necessarily be located in housing 11 of flat panel display 1 are thus preferably located within expansion device 2—with the result that the flat panel display can be produced in a minimal configuration at low expense and minimal dimensions.

FIG. 2 shows expansion device 2 of FIG. 1 without flat panel display 1. Provided on the front of housing 22 of expansion device 2 are openings 220 to enable connection of cables and introduction of data media 321 (see FIG. 6). In addition, a keypad 4 is shown by which control commands are wirelessly transmittable to computer module 31.

Expansion device 2 can be installed in a variety of ways. First, expansion device 2 can be placed on a base. Secondly, expansion device 2 can mounted in a suspended manner using mounting device 5 (see FIGS. 4 through 7).

FIG. 4 shows, in a preferred embodiment, expansion device 2 which is mounted in a suspended manner by mounting device 5 held by rod 6 and which supports flat panel display 1. Support device 21 provided in expansion device 2 has an L-shaped connecting element 216 extending outward (see FIG. 4a), which element is connected to a head piece 52 of mounting device 5, which head piece surrounds a mounting block 51 and is hinge-connected by a horizontally aligned shaft 53 to mounting block 51 which in turn both surrounds rod 6 and is held by screws 54. The tilt of head piece 52 can be adjusted by adjustment screws 56, as is shown in FIG. 4a.

FIG. 5 shows support device 21 consisting of a one-piece shaped part which encompasses interior space 2100 capable of accommodating modules 31, . . . , 3n. The adjoining end pieces of the shaped part are bent outward and upward at the top of support device 21, forming a two-dimensional retaining element 2110. Also shown is an opening 210 for loading the interior space 2100 of support device 21, which opening is preferably located on the back of support device 21. Preferably, only such openings 210 are provided on the front which serve to enable the connection of cables or insertion of data media. FIG. 5a shows support device 21 of FIG. 5 connected by a screw to mounting device 5.

FIG. 6 shows expansion device 2 and mounting device 5 of FIG. 4 which are attached to each other by a bracket 216 and screws 2160, as seen in a sectional view from the top.

FIG. 6a is a detail of expansion device 2 and mounting device 5 of FIG. 6 which are connected to each other without screws in a preferred embodiment. For this purpose, the end piece of bracket 216 is inserted into a receiving element 29 provided on pillar 212.

Support device 21 is located in a device housing 22 which is provided on the front with openings 220 for the loading of data media 321 or for the connection of cables, and on the back with an opening 220′ for the insertion and mounting of modules 31, . . . , 3n. In the present configuration, expansion device 2 is equipped with a computer modules 31, a driver unit 32 for exchangeable optical data media 321, and a driver unit 32′ for magnetic data media.

FIG. 7 shows expansion device 2 of FIG. 6 with support device 21 which has foot elements by means of which expansion device 2 and mounted flat panel display 1 are held in a stable manner.

FIG. 8 is a schematic view of a circuit configuration provided in expansion device 2 with modules 31, . . . , 3n which are connected through connection device 301, switching unit 300, and main interface 302 to video/graphics processing unit 303 provided in flat panel display 1. The video/graphics information supplied by modules 31, . . . , 3n, for example, in the form of TTL signals (TTL: Transistor Transistor Logic) or LVDS signals are separated from each other via connection device 301, for example, a so-called backplane, fed to one input each of switching unit 300 by which the video/graphics information from modules 31, . . . , 3n is switched through to an output connected to main interface 302. The LVDS technology is described, for example, in reference [5], An Overview of LVDS Technology (LVDS: Low Voltage Differential Signalling), National Semiconductor 1998, Publication number AN012326 (see also: IEEE Standard 15961.3). Modules 31, . . . , 3n connected to switching unit 300 have a graphics module to process the video/graphics data, and at least one processor. Of course individual units of modules 31, . . . , 3n can be connected to switching unit 300 through another module 31.

Modules 31, . . . , 3n, which are provided with a separate graphics module that is matched to the service functions of the respective modules 31, . . . , 3n, can thus be connected independently of a separately provided video card to the video control unit 303 provided in flat panel display 1, which control unit supplies control data to the driver units 111, 112 connected to display unit 113. The use of switching unit 300 results in a strictly modular design for the circuit configuration. The user is thus able to install in expansion device 2 any desired modules 31, . . . , 3n compatible with main interface 302 of flat panel display 1. In preferred embodiments, the interface of video/graphics control unit 303 is flexibly matched to the requirements of the connected modules 31, . . . , 3n, thereby further enhancing the flexibility and compatibility of flat panel display 1.

FIGS. 9, 10 and 11 show the above-described flat panel display 1′ and the expansion device 2′ of European Patent Application no. 03 405 797.6.

Expansion device 2 and flat panel display 1 have been described in preferred embodiments. Based on the teaching according to the invention, it is also possible to implement additional embodiments. In particular, it is possible to implement different dimensions for the device components, as well as different means for connecting and mutally adjusting the device components. In addition, it is also possible to exchange individual connection elements by kinematic reversal.

The mounting and electrical connection of modules 31, . . . , 3n within device housing 22 or within support device 21 are performed by operations known to a person skilled in the art. The dimensions of expansion device 2 are adapted to the size of modules 31, . . . , 3n.

Reference Literature

[1] European Offenlegungsschrift EP 1 265 210 A1

[2] International Offenlegungsschrift WO 02/25943

[3] European Offenlegungsschrift EP 1 244 000 A2

[4] U.S. Offenlegungsschrift US 2002/0120750 A1

[5] An Overview of LVDS Technology (LVDS: Low Voltage Differential Signalling), National Semiconductor 1998, Publication number AN012326 (see also: IEEE Standard 15961.3)

1. Expansion device for a flat panel display, comprising at least one module, including a computer module, which serve to store, transmit, or process video/graphics information which are transmittable to the large-format display unit held by a supporting structure of the flat panel display, characterized in that the expansion device has a support device with at least one retaining element which is located on the top of the support device and is able to engage a correspondingly designed receiving part located on the bottom of the supporting structure of the flat panel display, and which retaining element is able to hold the supporting structure in a fixed position relative to the support device.

2. Expansion device according to claim 1, characterized in that the support device and the at least one module are located in a device housing from which the at least one retaining element projects, or that the support device is composed of a shaped part provided with at least one retaining element, which part has an interior space to receive the at least one module and has at least one access opening.

3. Expansion device according to claim 1, characterized in that at least one mandrel-shaped, rod-shaped or plate-like retaining element is provided which is aligned vertically in a plane parallel to the display unit.

4. Expansion device according to claim 1, characterized in that the support device is provided on both sides with pillars which are connected to each other by a center piece and have bearing surfaces for the flat panel display, the pillars and the center piece preferably forming a U-shaped section in which the at least one module is inserted.

5. Expansion device according to claim 3, characterized in that the support device has at least one foot element, or is attachable to foot elements which serve to hold in a stable manner the expansion device placed on a base.

6. Expansion device according to claim 1, characterized in that the support device is connectable to a mounting device held by a rod or a wall, by means of which mounting device the expansion device and possibly the flat panel display mounted thereon, are installable in a suspended manner.

7. Expansion device according to claim 6, characterized in that the pillars and/or center piece of the support device are connectable through a bracket to the mounting device.

8. Expansion device according to claim 7, characterized in that the bracket is attachable by screws to the support device, and/or is able to be inserted therein.

9. Expansion device according to claim 1, characterized in that a switching unit is provided in the device housing, from which switching unit video/graphics information is able to be switched through from each of the modules to a video/graphics processing unit preferably provided in the flat panel display, which processing unit serves to control the driver units of the display unit.

10. Flat panel display connected to an expansion device according to claim 1, which expansion device has a device housing with at least one module, including a computer modules which serves to store, transmit or process video/graphics information that is transmittable wirelessly or by wire to the large-format display unit held by the supporting structure of the flat panel display, characterized in that the expansion device has a support device with at least one retaining element which is located on the top of the support device and engages a correspondingly designed receiving part located on the bottom of the supporting structure of the flat panel display, and which retaining element holds the supporting structure in a fixed position relative to the support device.

11. Flat panel display according to claim 10, characterized in that the support device and the at least one module are located in a device housing, from which the at least one retaining element projects, or that the support device is composed of a shaped part provided with at least one retaining element, which part has an interior space to receive the at least one module and has at least one access opening.

12. Flat panel display according to claim 10, characterized in that the supporting structure, which preferably surrounds the display unit in a frame-like fashion, has a preferably plate-like structural element that is parallel to the bottom of the display housing and possibly projects therefrom, which structural element has at least one receiving part and adjoins the support device, preferably, the bearing surfaces of the pillars.

13. Flat panel display according to claim 10, characterized in that a switching unit is provided in the device housing, from which switching unit video/graphics information is able to be switched through from each of the modules to a video/graphics processing unit preferably provided in the flat panel display, which processing unit serves to control the driver units connected to the display unit.

14. Flat panel display according to claim 10, characterized in that the expansion device supporting the flat panel display is able to be positioned on a base, or is able to be mounted in a suspended manner by means of a mounting device.
